(19) United States
(12) Patent Application Publication
(10) Pub. No.: US 2007/0179051 A1
(43) Pub. Date: Aug. 2, 2007

(54) Preparation of supported catalysts for polymerization

(75) Inventors: Shahram Mihan, Bad Soden (DE); Joachim Wulff-Doring, Frankenthal (DE); Alexander Koppl, Limburgerhof (DE); Wolfgang Rohde, Speyer (DE)

Correspondence Address: BASELL USA INC., INTELLECTUAL PROPERTY, 912 APPLETON ROAD, ELKTON, MD, 21921, US

(73) Assignee: Basell Polyolefine GmbH, Wesseling (DE)

(21) Appl. No.: 10/588,391

(22) PCT Filed: Feb. 2, 2005
(86) PCT No.: PCT/EP05/01031

§ 371 Date: Aug. 4, 2006

Related U.S. Application Data
(60) Provisional application No. 60/556,273, filed on Mar. 24, 2004.

(30) Foreign Application Priority Data
Feb. 6, 2004 (DE) 10 2004 006 104.1

(51) Int. Cl. C08F 2/00; B01J 23/00

(52) U.S. Cl. 502/300; 526/74

(57) ABSTRACT

The invention relates to a process for preparing a supported catalyst, in particular for the polymerization and/or copolymerization of olefins, which comprises: a) preparing a hydrogel; b) milling the hydrogel to give a finely particulate hydrogel; c) producing a slurry based on the finely particulate hydrogel; d) drying the slurry comprising the finely particulate hydrogel to give the support for catalysts; e) producing the supported catalyst by applying at least one transition metal and/or at least one transition metal compound to the support for catalysts and, if appropriate, activating the applied metal and/or compound, wherein a finely particulate hydrogel in which at least 5% by volume of the particles, based on the total volume of the particles, have a particle size in the range from >0 μm to ≦3 μm; and/or at least 40% by volume of the particles, based on the total volume of the particles, have a particle size in the range from >0 μm to ≦12 μm, and/or at least 75% by volume of the particles, based on the total volume of the particles, have a particle size in the range from >0 μm to ≦35 μm, is produced in step b) and a support which can be prepared as set forth in steps a) to d) is used to produce catalysts in step e).

The present invention relates to a process for preparing supported catalysts, in particular catalysts for the polymerization and/or copolymerization of olefins, to the corresponding supported catalysts and to their use in polymerization.

Polymerizations are frequently carried out industrially as gas-phase or suspension polymerizations, for which homogeneous catalysts have only limited suitability. Agglomeration frequently occurs, with the consequence that the catalyst is deposited, for example, on the reactor walls, etc. Furthermore, homogeneous catalysts give fine polymer powders which cannot be conveyed. These can easily become electrostatically charged, which can lead to dust explosions. For this reason, supported catalysts have been developed.

Polymerization catalysts comprising inorganic compounds such as silicon oxides or aluminum oxides, for example silica gel or modified silica gel, as support material play an important role in the preparation of polymers. The composition of the support material has, like that of the catalyst, a critical influence on the performance of the catalyst in the polymerization process, the activity of the catalyst and the structure and properties of the polymer formed.

A disadvantage encountered when using supports rather than a homogeneous polymerization is a reduction in the activity of the catalyst. Granular supports known from the prior art have, for example, a low productivity and a high fines content, which leads to an uneconomical process.

Processes for preparing silica gels as support material for catalysts are well known in the prior art. A basic process for preparing a support material and a catalyst for the polymerization of unsaturated compounds is disclosed, for example, in DE-A 25 40 279. This starts out from a spherical silica hydrogel which has a particle diameter of from 1 mm to 8 mm.

WO 97/48742 discloses loosely aggregated catalyst support compositions which have a particle size of from 2 μm to 250 μm and a specific surface area of from 100 m²/g to 1000 m²/g, with the support particles comprising particles of an inorganic oxide having a mean particle size of less than 30 μm and a binder which loosely binds these particles to one another.

WO 97/48743 relates to fragile, agglomerated catalyst support particles which have a mean particle size of from 2 μm to 250 μm and a specific surface area of from 1 m²/g to 1000 m²/g and are prepared by spray drying primary particles having a mean particle size of from 3 μm to 10 μm.

The primary particles for producing the agglomerated catalyst support particles are provided as a slurry of dry and optionally wet-milled inorganic oxide particles in water.

EP 1 120 158 discloses catalyst systems of the Ziegler-Natta type which comprise, as support, a particulate inorganic oxide consisting of particles which are composed of primary particles having a mean particle diameter in the range from 1 μm to 10 μm and have voids between the primary particles.

Disadvantages of the fragile agglomerated catalyst support particles are, in particular, that they produce polymers whose fines content is very high. The term “fines content” refers to the fraction of the polymer having a particle size of less than 250 μm.

A high fines content can lead to drawbacks in the polymerization process, for example in the reactor or in depressurization, to poor handlability of the polymer, for example during transport, and to problems with the polymer product, for example in respect of flowability.

For example, a high fines content can lead to the fines being able to become electrically charged in the reactor so that deposits are formed in the reactor or the fines can, particularly in gas-phase processes, accumulate in, for example, lines, especially the discharge lines, and block these. This can necessitate shutdown of the plant. Furthermore, a high fines content can, especially in suspension processes, lead to problems in, for example, the downstream region. Thus, a high fines content can lead to the fines together with solvents such as hydrocarbons or, for example, with hexane added to the polymerization causing conglutination of the polymer, for example in the depressurization vessel.

Furthermore, a high fines content can adversely affect transport of the polymer, in particular in the case of pneumatic transport. In addition, a high fines content in transport lines or during storage of the polymers, for example in hoppers, can lead to separation of the fines or electrostatic charging. Electrostatic charging can lead to dust explosions during transport or storage of the polymer. Furthermore, a high fines content can adversely affect the flowability or trickling properties of the polymer. For example, impaired flowability can cause problems in the extruder, in particular at the extruder screws.

It is an object of the present invention to provide a process for preparing supported catalysts and supported catalysts themselves which overcome at least one of the abovementioned disadvantages of the prior art.

We have found that this object is achieved by a process for preparing a supported catalyst, in particular for the polymerization and/or copolymerization of olefins, which comprises:
a) preparing a hydrogel;
b) milling the hydrogel to give a finely particulate hydrogel;
c) producing a slurry based on the finely particulate hydrogel;
d) drying the slurry comprising the finely particulate hydrogel to give the support for catalysts;
e) producing the supported catalyst by applying at least one transition metal and/or at least one transition metal compound to the support for catalysts and, if appropriate, activating the applied metal and/or compound,
   wherein a finely particulate hydrogel in which
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm,
   is produced in step b) and a support which can be prepared as set forth in steps a) to d) is used to produce catalysts in step e).

Advantageous embodiments of the process of the present invention are set forth in the subordinate claims.

The invention further provides supported catalysts which can be prepared according to the present invention and also provides for their use, in particular for the polymerization and/or copolymerization of olefins.

The invention also provides polymers of olefins which are obtainable using supported catalysts which can be prepared according to the present invention, and also fibers, films and/or moldings comprising polymers of olefins which are obtainable using supported catalysts which can be prepared according to the present invention.

For the purposes of the invention, a catalyst is a preferably supported catalyst. For the purposes of the invention, a supported catalyst is a catalyst system comprising a support, at least one transition metal and/or at least one compound of a transition metal and, if appropriate, one or more activators.

It has surprisingly been found that when supported catalysts which can be prepared according to the present invention are used, the polymers obtained have, in preferred embodiments, a higher bulk density and at the same time have a lower fines content.

For the purposes of the present invention, supports are the particles which can be produced in accordance with the process of the present invention. These particles can serve as supports for catalysts. Furthermore, the particles which can be prepared according to the present invention can themselves have catalytic activity.

For the purposes of the present invention, the particles produced in step b) are preferably hydrogel particles and not xerogel particles or oxide particles. Data relating to particle size, diameter or the mean particle size are based on hydrogel particles.

Hydrogels are water-containing gels of inorganic hydroxides, preferably those based on silicon which are present as a three-dimensional network. Xerogels are gels from which water has been withdrawn, for example by solvent exchange or drying, so that the water content of the gel is less than 40% by weight, based on the total weight of the gel.

The water content of the hydrogel which can be prepared according to the present invention is preferably at least 80% by weight, more preferably at least 90% by weight, based on the total weight of the hydrogel.

For the purposes of the present invention, the term “hydrogel” refers to all hydrogels which are suitable for producing supports, preferably those based on inorganic hydroxides. The term “hydrogel” preferably refers to hydrogels based on silicon-containing starting materials, particularly preferably to hydrogels based on silica.

The preparation of a silica hydrogel is preferably carried out by acidic or basic precipitation from water glass. The hydrogel is preferably prepared by introducing a sodium or potassium water glass solution into a twisting stream of a mineral acid, e.g. sulfuric acid. The silica hydrosol formed is subsequently sprayed into a gaseous medium by means of a nozzle. The nozzle end used here leads, after allowing the hydrosol to solidify in the gaseous medium, to hydrogel particles having a mean particle size which can be varied in a range from, for example, 1 mm to 20 mm by selection of the nozzle. The hydrogel particles preferably have a mean particle size in the range from 2 mm to 10 mm, more preferably in the range from 5 mm to 6 mm. Washing of the hydrogel particles can be carried out in any way, preferably with weakly ammoniacal water having a temperature of about 50° C.-80° C. in a continuous countercurrent process.

In a preferred embodiment, the hydrogel particles can optionally be subjected to an aging step in the range from 1 hour to 100 hours, preferably in the range from 5 hours to 30 hours, prior to washing and/or after washing with the alkaline solution, which enables pore volume, surface area and/or mean pore radius of the support to be adjusted.

The hydrogel particles can be sieved and fractions having a preferred diameter isolated.

The hydrogel according to the present invention is preferably not formed from a slurry of oxides and/or xerogels in water or another solvent. A hydrogel which can be used according to the present invention is preferably a silica hydrogel prepared by a process as described above.

Apart from spray drying a hydrosol, it is likewise possible to use other methods known from the prior art for preparing the hydrogel. For example, hydrogels, preferably silica hydrogels, which can be prepared in a manner known from the prior art, for example from silicon-containing starting materials such as alkali metal silicates, alkyl silicates and/or alkoxysilanes, can likewise be used for preparing supports according to the present invention.

The size of the hydrogel particles which can be used can vary within a wide range, for example in a range from a few microns to a few centimeters. The size of hydrogel particles which can be used is preferably in the range from 1 mm to 20 mm, but it is likewise possible to use hydrogel cakes. It is advantageous to use hydrogel particles which have a size in the range ≦6 mm. These are obtained, for example, as by-product in the production of granular supports.

Hydrogels which can be prepared according to step a) are preferably substantially spherical. Furthermore, hydrogels which can be prepared according to step a) preferably have a smooth surface. Silica hydrogels which can be prepared according to step a) preferably have a solids content in the range from 10% by weight to 25% by weight, preferably in the region of 17% by weight, calculated as SiO₂.

The finely particulate hydrogel produced in step b) preferably has a solids content in the range from >0% by weight to ≦25% by weight, more preferably in the range from 5% by weight to 15% by weight, in particular in the range from 8% by weight to 13% by weight, particularly preferably in the range from 9% by weight to 12% by weight, very particularly preferably in the range from 10% by weight to 11% by weight, calculated as oxide. Particular preference is given to producing a finely particulate silica hydrogel having a solids content in the range from >0% by weight to ≦25% by weight, preferably in the range from 5% by weight to 15% by weight, more preferably in the range from 8% by weight to 13% by weight, particularly preferably in the range from 9% by weight to 12% by weight, very particularly preferably in the range from 10% by weight to 11% by weight, calculated as SiO₂, in step b). The solids content is preferably set by dilution, for example by addition of deionized water.

The hydrogel is milled to give a finely particulate hydrogel. According to the present invention, the hydrogel is milled to give very fine particles. According to the present invention, a hydrogel in which
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm,
   is produced in step b).

When, for the purposes of the present invention, mention is made of % by volume or % by weight, it goes without saying that the respective proportions in % by volume or % by weight are chosen so that they do not exceed 100% by volume or 100% by weight, based on the respective total composition.

The advantages of the support which can be prepared from hydrogel particles which have been milled according to the present invention result from the support preferably having a compact microstructure. Without being tied to a particular theory, it is assumed that the hydrogel particles according to the present invention can be agglomerated in a high packing density in the formation of the support.

Catalyst systems comprising supports which can be prepared according to the present invention from hydrogel particles which can be produced according to step b) advantageously have a particularly good productivity.

A preferred particle size distribution of the finely particulate hydrogel is one in which at least 75% by volume, preferably at least 80% by volume, more preferably at least 90% by volume, of the hydrogel particles, based on the total volume of the particles, have a particle size in the range from >0 μm to ≦35 μm, preferably in the range from >0 μm to ≦30 μm, more preferably in the range from >0 μm to ≦25 μm, in particular in the range from >0 pm to ≦20 pm, more preferably in the range from >0 μm to ≦18 μm, even more preferably in the range from >0 μm to ≦16 μm, particularly preferably in the range from >0 μm to ≦15 μm, more particularly preferably in the range from >0 μm to ≦14 μm, very particularly preferably in the range from >0 μm to ≦13 μm, especially preferably in the range from >0 μm to ≦12 μm, most preferably in the range from >0 μm to ≦11 μm.

A more preferred particle size distribution of the finely particulate hydrogel is one in which at least 75% by volume, preferably at least 80% by volume, more preferably at least 90% by volume, of the hydrogel particles, based on the total volume of the particles, have a particle size in the range from ≧0.1 μm to ≦35 μm, preferably in the range from ≧0.1 μm to ≦30 μm, more preferably in the range from ≧0.1 μm to ≦25 μm, in particular in the range from ≧0.1 μm to ≦20 μm, more preferably in the range from ≧0.1 μm to ≦18 μm, even more preferably in the range from ≧0.1 μm to ≦16 μm, particularly preferably in the range from ≧0.1 μm to ≦15 μm, more particularly preferably in the range from ≧0.1 μm to ≦14 μm, very particularly preferably in the range from ≧0.1 μm to ≦13 μm, especially preferably in the range from ≧0.1 μm to ≦12 μm, most preferably in the range from ≧0.1 μm to ≦11 μm.

A particularly preferred particle size distribution of the finely particulate hydrogel is one in which at least 75% by volume, preferably at least 80% by volume, more preferably at least 90% by volume, of the hydrogel particles, based on the total volume of the particles, have a particle size in the range from ≧0.2 μm to ≦35 μm, preferably in the range from ≧0.2 μm to ≦30 μm, more preferably in the range from ≧0.2 μm to ≦25 μm, in particular in the range from ≧0.2 μm to ≦20 μm, more preferably in the range from ≧0.2 μm to ≦18 μm, even more preferably in the range from ≧0.2 μm to ≦16 μm, particularly preferably in the range from ≧0.2 μm to ≦15 μm, more particularly preferably in the range from ≧0.2 μm to ≦14 μm, very particularly preferably in the range from ≧0.2 μm to ≦13 μm, especially preferably in the range from ≧0.2 μm to ≦12 μm, most preferably in the range from ≧0.2 μm to ≦11 μm.

The supports which can be prepared from the hydrogel particles according to the present invention preferably have a high homogeneity. A high homogeneity of the support can lead to the application of a catalyst to the support likewise being able to be carried out very homogeneously and the polymerization products being able to have higher molecular weights.

It is preferred that the finely particulate hydrogel has a narrow distribution of the particle sizes. For example, at least 40% by volume, preferably at least 50% by volume, of the hydrogel particles, based on the total volume of the particles, can have a particle size in the range from >0 μm to ≦10 μm, preferably in the range from >0 μm to ≦8 μm, more preferably in the range from >0 μm to ≦7 μm, particularly preferably in the range from >0 μm to ≦6.5 μm, more particularly preferably in the range from >0 μm to ≦6 μm, very particularly preferably in the range from >0 μm to ≦5.5 μm, especially preferably in the range from >0 μm to ≦5 μm, most preferably in the range from >0 μm to ≦4.5 μm.

Further preference is given to at least 40% by volume, preferably at least 50% by volume, of the hydrogel particles, based on the total volume of the particles, having a particle size in the range from ≧0.1 μm to ≦10 μm, preferably in the range from ≧0.1 μm to ≦8 μm, more preferably in the range from ≧0.1 μm to ≦7 μm, particularly preferably in the range from ≧0.1 μm to ≦6.5 μm, more particularly preferably in the range from ≧0.1 μm to ≦6 μm, very particularly preferably in the range from ≧0.1 μm to ≦5.5 μm, especially preferably in the range from ≧0.1 μm to ≦5 μm, most preferably in the range from ≧0.1 μm to ≦4.5 μm.

Furthermore, preferably at least 40% by volume, preferably at least 50% by volume, of the hydrogel particles, based on the total volume of the particles, advantageously have a particle size in the range from ≧0.2 μm to ≦10 μm, preferably in the range from ≧0.2 μm to ≦8 μm, more preferably in the range from ≧0.2 μm to ≦7 μm, particularly preferably in the range from ≧0.2 μm to ≦6.5 μm, more particularly preferably in the range from ≧0.2 μm to ≦6 μm, very particularly preferably in the range from ≧0.2 μm to ≦5.5 μm, especially preferably in the range from ≧0.2 μm to ≦5 μm, most preferably in the range from ≧0.2 μm to ≦4.5 μm.

It is advantageous for at least 5% by volume, preferably at least 7.5% by volume, particularly preferably at least 10% by volume, of the hydrogel particles, based on the total volume of the particles, to have a particle size in the range from >0 μm to ≦2.8 μm, particularly preferably from >0 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from >0 μm to ≦2.4 μm, preferably in the range from >0 μm to ≦2.2 μm, particularly preferably in the range from >0 μm to ≦2.0 μm, more preferably in the range from >0 μm to ≦1.8 μm, even more preferably in the range from >0 μm to ≦1.6 μm, very particularly preferably in the range from >0 μm to ≦1.5 μm.

It is even more advantageous for at least 5% by volume, preferably at least 7.5% by volume, particularly preferably at least 10% by volume, of the hydrogel particles, based on the total volume of the particles, to have a particle size in the range from ≧0.1 μm to ≦2.8 μm, particularly preferably from ≧0.1 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from ≧0.1 μm to ≦2.4 μm, preferably in the range from ≧0.1 μm to ≦2.2 μm, particularly preferably in the range from ≧0.1 μm to ≦2.0 μm, more preferably in the range from ≧0.1 μm to ≦1.8 μm, even more preferably in the range from ≧0.1 μm to ≦1.6 μm, very particularly preferably in the range from ≧0.1 μm to ≦1.5 μm.

It is particularly advantageous for at least 5% by volume, preferably at least 7.5% by volume, particularly preferably at least 10% by volume, of the hydrogel particles, based on the total volume of the particles, to have a particle size in the range from ≧0.2 μm to ≦2.8 μm, particularly preferably from ≧0.2 μm to ≦2.5 μm. It is particularly advantageous for at least 5% by volume, preferably at least 7.5% by volume, particularly preferably at least 10% by volume, of the hydrogel particles, based on the total volume of the particles, to have a particle size in the range from ≧0.2 μm to ≦2.4 μm, preferably in the range from ≧0.2 μm to ≦2.2 μm, particularly preferably in the range from ≧0.2 μm to ≦2.0 μm, more preferably in the range from ≧0.2 μm to ≦1.8 μm, even more preferably in the range from ≧0.2 μm to ≦1.6 μm, very particularly preferably in the range from ≧0.2 μm to ≦1.5 μm. It is especially advantageous for at least 10% by volume of the hydrogel particles, based on the total volume of the particles, to have a particle size in the range from ≧0.5 μm to ≦3 μm, more preferably in the range from ≧0.5 μm to ≦2.5 μm.

Preference is given to a finely particulate hydrogel which has a preferably narrow particle size distribution in which
at least 10% by volume of the particles, based on the total volume of the particles, have a particle size in the range from >0 μm to ≦2.5 μm, preferably in the range from >0 μm to ≦2.0 μm, more preferably in the range from >0 μm to ≦1.8 μm, particularly preferably in the range from >0 μm to ≦1.6 μm; and/or
at least 50% by volume of the particles, based on the total volume of the particles, have a particle size in the range from >0 μm to ≦8 μm, preferably in the range from >0 μm to ≦7 μm, more preferably in the range from >0 μm to ≦5 μm, particularly preferably in the range from >0 μm to ≦4 μm, and/or
at least 90% by volume of the particles, based on the total volume of the particles, have a particle size in the range from >0 μm to ≦21 μm, preferably in the range from >0 μm to ≦16 μm, more preferably in the range from >0 μm to ≦14 μm, particularly preferably in the range from >0 μm to ≦12 μm,
   being produced in step b).

Furthermore,
at least 5% by volume of the particles, based on the total volume of the particles, can have a particle size in the range ≧2 μm; and/or
at least 10% by volume of the particles, based on the total volume of the particles, can have a particle size in the range ≧1 μm.

The hydrogel can have a mean particle size in the range from ≧1 μm to ≦8 μm. The hydrogel preferably has a mean particle size in the range from ≧1.2 μm to ≦6 μm, more preferably in the range from ≧1.5 μm to ≦5 μm, particularly preferably in the range from ≧2 μm to ≦4 μm.

The quoted particle sizes according to the present invention relate to hydrogel particles in the sense of the invention, preferably not to particles of a gel from which water has been withdrawn or an oxide. The size of the hydrogel particles can be reduced by drying of a gel to down to one-tenth of the size of the undried hydrogel. The quoted sizes of the hydrogel particles according to the present invention preferably relate to a hydrogel from which no water has been withdrawn before it is milled. The particle sizes quoted preferably do not relate to particles which have been formed from a slurry of inorganic oxides, oxide-hydroxides and/or xerogels in water or another solvent. The indicated sizes of the hydrogel particles which can be prepared according to the present invention thus preferably relates to particles which are significantly different from the particles used in the prior art.

According to the present invention, preference is given to milling a hydrogel in step b). During this milling step, additions of inorganic oxides, oxide-hydroxides and/or xerogels can be added to the hydrogel. The hydrogel is preferably milled moist and/or wet to give a finely particulate hydrogel. Moist or wet milling relates to the milling of a hydrogel which is preferably not dried up to the point of milling and/or from which preferably no water has been withdrawn prior to milling. Furthermore, the conditions of the milling step are selected so that preferably no water is withdrawn from the hydrogel during the milling process. The hydrogel is preferably not dry milled in step b).

“Oxide-hydroxides” are, for the purposes of the present invention, compounds which have a lower water content than a hydrogel without the water having been withdrawn from the compound to form the corresponding oxide.

Milling of the hydrogel can be carried out in a suitable mill, for example in a pin mill or an impingement plate mill; the hydrogel is preferably milled wet in a stirred ball mill. The milling of the hydrogel can be carried out in one step and/or in one mill or in a plurality of steps and/or in different mills. Before the hydrogel is finely milled, the hydrogel can be subjected to preliminary crushing or preliminary milling.

The advantageous properties of the support for catalysts result from the hydrogel particles being finely milled according to the present invention. The supports which can be prepared by the process of the present invention lead, after application of catalyst compounds, to supported catalysts which, in preferred embodiments, have a surprisingly high productivity. This is particularly surprising since, according to general teachings, very small, finely milled hydrogel particles lead to support particles which have a very high packing density, which would cause a decrease in the productivity of the catalyst.

The finely particulate hydrogel particles can be sieved after milling. The finely particulate hydrogel is converted into a slurry comprising finely particulate moist hydrogel, preferably silica hydrogel. The production of a slurry can, for example, comprise setting of the solids content, setting of the pH, setting of the viscosity, addition of hydroxides, oxide-hydroxides, oxides and/or salts, additives and/or fillers.

In advantageous embodiments, additives can be added to the slurry and/or the hydrogel in step b), in particular prior to milling. Addition in step b) preferably means, for the purposes of the present invention, that the additives are preferably added prior to milling and are preferably milled together with the hydrogel. The addition of materials selected from the group consisting of hydroxides, oxide-hydroxides, oxides and/or salts, additives and/or fillers and/or adjustment of the pH can advantageously be provided in step b) of the process of the present invention.

Suitable inorganic hydroxides, oxide-hydroxides and/or oxides are, for example, selected from the group consisting of hydroxides, oxide-hydroxides and oxides of silicon, aluminum, titanium, zirconium and metals of main group I or II of the Periodic Table and mixtures thereof. Preference is given to adding inorganic hydroxides, oxide-hydroxides, oxides and/or salts, preferably selected from the group consisting of SiO₂, Al₂O₃, MgO, AlPO₄, TiO₂, ZrO₂, Cr₂O₃ and mixtures thereof to the hydrogel in step b) and/or the slurry in step c). Very particular preference is given to inorganic hydroxides, oxide-hydroxides, oxides and/or salts selected from the group consisting of Al₂O₃, AlOOH, AlPO₄ and ZrO₂. Magnesium oxide and/or sheet silicates are also preferred. It is also possible to use mixed oxides such as aluminum silicates or magnesium silicates. It is possible to add freshly prepared hydroxides, oxide-hydroxides, oxides and/or salts, but also commercially available compositions. Preference is given to adding wet-milled, inorganic hydroxides, oxide-hydroxides and/or oxides to the hydrogel and/or the slurry. The process of the present invention can also provide for the hydrogel and/or the slurry to be produced without addition of dry-milled inorganic oxides selected from the group consisting of SiO₂, Al₂O₃, MgO, AlPO₄, TiO₂, ZrO₂, Cr₂O₃ and mixtures thereof.

The proportion of hydroxides, oxide-hydroxides, oxides and/or salts which can be added can vary within a wide range. The proportion of hydroxides, oxide-hydroxides, oxides and/or salts which can be added is preferably in the range from 1% by weight to 70% by weight, based on the total solids content of the hydrogel and/or the slurry. Preference is given to adding inorganic hydroxides, oxide-hydroxides, oxides and/or salts to the hydrogel in step b) and/or to the slurry in step c) in an amount of ≦10% by weight, preferably ≦5% by weight, particularly preferably ≦2% by weight, based on the total solids content. Aluminum compounds can advantageously be added in higher proportions by weight.

According to the present invention, preference is given to adding compounds of aluminum, for example AlOOH (pseudoboehmite), AlPO₄ and/or Al₂O₃, to the hydrogel and/or the slurry. Preference is given to adding AlOOH to the hydrogel in step b) and/or to the slurry in step c) in an amount of from 1% by weight to 30% by weight, preferably from 5% by weight to 20% by weight, based on the total solids content. Further preference is given to adding AlOOH to the hydrogel and/or the slurry in an amount of from 3% by weight to 18% by weight, preferably from 5% by weight to 15% by weight, more preferably from 6% by weight to 12% by weight, particularly preferably from 6% by weight to 10% by weight, based on the total solids content.

The % by weight figures quoted for the addition of hydroxide compounds, in particular AlOOH, is, unless indicated otherwise, calculated as the oxide, in particular Al₂O₃, and based on the total solids content calculated as oxide.

Furthermore, Al₂O₃ can be added to the hydrogel in step b) and/or to the slurry in step c) in an amount of from 1% by weight to 30% by weight, preferably from 5% by weight to 20% by weight, based on the total solids content. Further preference is given to adding Al₂O₃ to the hydrogel and/or the slurry in an amount of from 3% by weight to 18% by weight, preferably from 5% by weight to 15% by weight, more preferably from 6% by weight to 12% by weight, particularly preferably from 6% by weight to 10% by weight, based on the total solids content. Aluminum compounds can, for example, be added in the form of the commercially available products Pural SB, Disperal and/or Apyral, obtainable from the companies Sasol Ltd. and Nabaltec GmbH.

AlPO₄ can be added to the hydrogel and/or the slurry in widely varying proportions by weight, for example in amounts of from 30% by weight to 70% by weight, based on the total solids content.

Furthermore, hydroxides, oxide-hydroxides and/or oxides of zirconium, for example zirconium hydroxide and/or ZrO₂, can be added to the hydrogel and/or the slurry. Zirconium hydroxide and/or ZrO₂ is preferably milled wet. Preference is given to adding ZrO₂ to the hydrogel and/or the slurry in an amount of from 1% by weight to 10% by weight, preferably from 2% by weight to 6% by weight, based on the total solids content.

The hydroxides, oxide-hydroxides and/or oxides which can be added are preferably milled wet. Furthermore, the hydroxides, oxide-hydroxides and/or oxides preferably have a mean particle size in the range from 1 μm to 10 μm. The hydroxides, oxide-hydroxides and/or oxides can be milled together with the hydrogel in step b) and/or can be milled separately, preferably wet, but it can also be provided according to the present invention for the slurry comprising the finely milled hydrogel and hydroxides, oxide-hydroxides and/or oxides which can optionally be added to be milled in step c), preferably milled wet. The milling of the hydrogel and/or the slurry can be repeated a number of times.

In preferred embodiments, compounds of the alkaline earth metals, preferably compounds selected from the group consisting of hydroxides and oxides of alkaline earth metals, for example compounds selected from the group consisting of magnesium hydroxide, calcium hydroxide, magnesium oxide and calcium oxide, can be added in step b). Preference is given to adding Ca(OH)₂ and/or Mg(OH)₂ to the hydrogel in step b) in amounts of from 1% by weight to 10% by weight, preferably from 2% by weight to 4% by weight, based on the total solids content.

Furthermore, large organic molecules, for example polymers, hydroxycellulose, polyethylene glycol, polyamines, anionic and/or cationic surfactants, can be added to the slurry and/or the hydrogel, in particular as templates for optimizing the support structure by forming voids after calcination, preferably in an oxidizing atmosphere.

Preference is given to producing an aqueous slurry in step c). The solvent of the hydrogel in step b) and/or of the slurry in step c) can, however, be replaced at least partially; for example, the hydrogel and/or the aqueous slurry can comprise organic solvents, for example aliphatic alcohols, preferably toluene and/or a methanol/glycerol mixture. Replacement of the solvent preferably comprises replacement of up to 50% by weight, based on the total weight of the hydrogel and/or the slurry, of water. The hydrogel in step b) and/or the slurry in step c) preferably has a water content of at least about 50% by weight, based on the total weight of the hydrogel and/or the slurry. Spray drying of the support particles is preferably carried out, for example, from an aqueous solution, but it can be advantageous for at least part of the solvent to be replaced prior to spray drying.

The pH of the hydrogel in step b) and/or the slurry in step c) can vary, but the pH of the hydrogel and/or the slurry is preferably in the neutral to basic range. The pH of the hydrogel and/or the slurry can advantageously be set to values in the range from 8 to 11, and the pH of the slurry after the adjustment is preferably in the range from 8 to 10. The adjustment of the pH of the hydrogel and/or the slurry can be carried out by means of suitable acids or bases, preferably by means of NH₄OH.

It is also possible for a binder which can aid the particle formation process, for example during spray drying, and/or improve the cohesion of the particles to be added to the hydrogel in step b) and/or to the slurry in step c). Binders used can be particularly fine, e.g. colloidal, particles of inorganic oxides. However, it is also possible to add auxiliaries, for example polymers such as cellulose derivatives, polystyrene and/or polymethyl methacrylate as binders. It is advantageous to add hydroxymethylcellulose to the hydrogel in step b) and/or to the slurry in step c), preferably in an amount of from 0.1% by weight to 10% by weight, particularly preferably from 1% by weight to 2% by weight, based on the total solids content.

The viscosity of the slurry in step c) can advantageously be modified. The viscosity of the slurry can be increased, for example, by addition of compounds of the alkaline earth metals, preferably compounds selected from the group consisting of hydroxides and oxides of alkaline earth metals, for example compounds selected from the group consisting of magnesium hydroxide, calcium hydroxide, magnesium oxide and calcium oxide. Preference is given to adding Ca(OH)₂ and/or Mg(OH)₂ to the slurry in step c) in amounts of from 1% by weight to 10% by weight, preferably from 2% by weight to 4% by weight, based on the total solids content. The viscosity of the slurry has, for example, a significant effect on the particle size of the support particles produced by spray drying.

An important factor in the preparation of the support for catalysts is the solids content of the slurry. It is usual to use high solids contents in the range from 10% by weight to 25% by weight, based on the total weight. According to the present invention, the solids content of the slurry is set to ≦20% by weight, preferably ≦15% by weight, more preferably ≦12% by weight, particularly preferably ≦10% by weight, more particularly preferably in the range from 5% by weight to 10% by weight, very particularly preferably in the range from 8% by weight to 10% by weight, based on the total weight, in step c) prior to drying.

Surprisingly, a low solids content of the slurry leads to support particles which have particularly advantageous particle diameters.

The size of the particles can be adjusted again before drying, for example by filtering and/or sieving the slurry, for example via a sieve of suitable size.

The order in which the process steps a) to d) are carried out is, according to the present invention, not restricted to the order described, but preference is given to carrying out the steps in the order indicated.

Drying of the slurry comprising the finely particulate hydrogel to give the support is preferably carried out by spray drying. However, it can also be preferred according to the present invention for drying to be carried out by other methods, for example by thermal drying, drying under reduced pressure and/or by extraction of the water by means of an organic solvent. Furthermore, drying of the slurry comprising the finely particulate hydrogel can also be carried out by means of a combination of suitable methods. Furthermore, the spray-dried support particles can, for example, be additionally dried thermally. Drying of the slurry comprising the finely particulate hydrogel is preferably carried out by means of spray drying.

The support particles are preferably produced by spray drying the slurry comprising the finely particulate hydrogel. The spray drying conditions can be varied within a wide range. The properties of the support particles after spray drying are determined largely by the properties of the slurry, so that the individual spray-drying parameters are not particularly critical in determining the properties of the support. The settings for the spray-drying parameters in order to achieve the desired properties of the support particles, e.g. temperature, gas flow, gas inlet and outlet temperature and/or initial and final moisture content, are known to those skilled in the art and are selected according to the nature of the apparatus.

The support particles which can advantageously be produced by spray drying generally have a spheroidal, i.e. sphere-like, shape. The desired mean particle size of the supports after spray. drying can be varied within a wide range and can be matched appropriately to the use of the supports. The mean particle size of the supports can thus be set, for example, to meet the requirements of various polymerization processes.

The support particles which are preferably produced by means of spray drying preferably have a mean particle size in the range from 1 μm to 350 μm, preferably in the range from 30 μm to 150 μm and particularly preferably in the range from 40 μm to 100 μm. The support particles which are preferably produced by means of spray drying particularly preferably have a mean particle size in the range from 30 μm to 90 μm, more preferably in the range from 40 μm to 70 μm, particularly preferably in the range from 40 μm to 50 μm and very particularly preferably in the range from 40 μm to 55 μm.

It is particularly preferred that from 70% by volume to 90% by volume of the support particles, preferably 80% by volume of the particles, based on the total volume of the particles, have a mean particle size in the range from ≧40 μm to ≦90 μm.

Support particles which are preferably used for polymerization by a slurry polymerization process preferably have mean particle sizes up to 350 μm and particularly preferably have a mean particle size in the range from 30 μm to 150 μm. Support particles which are preferably used for polymerization in a gas-phase fluidized-bed process preferably have a mean particle size in the range from 30 μm to 120 μm. Support particles which are preferably used for polymerization in a suspension process preferably have a mean particle size in the range from 30 μm to 300 μm. Support particles which are preferably used for polymerization in a lop process preferably have a mean particle size in the range from 30 μm to 150 μm. Support particles which can be used, for example, for polymerization in fixed-bed reactors preferably have mean particle sizes of ≧100 μm, preferably ≧300 μm, more preferably in the range from 1 mm to 10 mm, particularly preferably in the range from 2 mm to 8 mm and even more preferably in the range from 2.5 mm to 5.5 mm.

Preference is given to from 10% by volume to 90% by volume of the support particles which can be produced in step d), based on the total volume of the particles, having a particle size in the range from ≧40 μm to ≦120 μm. It is even more preferred that from 30% by volume to 80% by volume of the particles, based on the total volume of the particles, have a particle size in the range from ≧30 μm to ≦70 μm. Particular preference is given to particle sizes of the support particles in the range from ≧30 μm to ≦70 μm.

The support particles which can be produced in step d) preferably have a particle size distribution, in particular of the output from the spray dryer, in which ≧90% by volume, based on the total volume of the particles, of particles have a size in the range from ≧16 μm to ≦500 μm, ≧75% by volume of the particles have a size in the range from ≧32 μm to ≦200 μm and ≧30% by volume of the particles have a size in the range from ≧48 μm to ≧150 μm.

The support particles after drying, in particular after spray drying, particularly advantageously have a low fines content. For the purposes of the present invention, the fines content of the support particles is the proportion of support particles having a particle size of less than 25 μm, preferably less than 22 μm, particularly preferably less than 20.2 μm. It is advantageous for ≦5% by volume of the particles after drying, based on the total volume of the particles, to have a particle size in the range from >0 μm to ≦25 μm, preferably in the range from >0 μm to ≦22 μm, particularly preferably in the range from >0 μm to ≦20.2 μm. Preference is given to <3% by volume, particularly preferably ≦2% by volume, of the particles, based on the total volume of the particles, having a particle size in the range from >0 μm to ≦25 μm, preferably in the range from >0 μm to ≦22 μm, particularly preferably in the range from >0 μm to ≦20.2 μm. Even greater preference is given to ≦5% by volume, preferably ≦2% by volume, of the particles, based on the total volume of the particles, having a particle size in the range from >0 μm to ≦10 μm. Furthermore, it is preferred that ≦30% by volume, preferably ≦20% by volume, particularly preferably ≦15% by volume, very particularly preferably ≦10% by volume, of the particles, based on the total volume of the particles, have a particle size in the range from >0 μm to ≦35 μm, preferably in the range from >0 μm to ≦32 μm.

A higher proportion of fines in the support particles can subsequently lead to a high fines content of the polymers produced using these supports. Thus, a great advantage of the supports used according to the present invention is realized by the support particles having a low fines content, particularly after spray drying.

It has surprisingly been found that the support particles which can be prepared according to the present invention are very compact support particles which can, after application of catalyst compounds, display a surprisingly high activity in polymerization reactions without the support particles having a very high fragility, as preferred in the prior art.

The support particles which can be prepared according to the present invention have a pore volume which is preferably in the range from 0.2 ml/g to ≦1.6 ml/g, more preferably in the range from 0.5 ml/g to <1.4 ml/g, particularly preferably in the range from 0.8 ml/g to 1.35 ml/g. The support particles which can be prepared according to the present invention have a pore diameter which is preferably in the range from 10 Å to ≦200 Å, more preferably in the range from 20 Å to ≦150 Å, particularly preferably in the range from 50 Å to 130 Å.

Catalysts based on granular supports frequently have a lower productivity than those based on spray-dried supports. Furthermore, granular supports frequently have a higher strength than spray-dried supports. The surprising advantage of the supports which can be prepared according to the present invention over granular supports is that they display, in particularly preferred embodiments, a higher catalytic activity than granular supports having a comparable strength.

The surface area of the inorganic support can likewise be varied within a wide range by means of the drying step, in particular by means of the spray drying process. Preference is given to producing particles of the inorganic support, in particular a spray dryer output, which have a surface area in the range from 100 m²/g to 1 000 m²/g, preferably in the range from 150 m²/g to 700 m²/g and particularly preferably in the range from 200 m²/g to 500 m²/g. Supports which can be used for polymerization preferably have a surface area in the range from 200 m²/g to 500 m²/g. The specific surface area of the support particles is, for the present purposes, the surface area of the support particles determined by means of nitrogen adsorption in accordance with the BET technique.

The bulk density of the inorganic supports for catalysts is preferably in the range from 250 g/l to 1200 g/l, and can vary as a function of the water content of the support. The bulk density of water-containing support particles is preferably in the range from 500 g/l to 1000 g/l, more preferably in the range from 600 g/l to 950 g/l and particularly preferably in the range from 650 g/l to 900 g/l. In the case of supports which contain no water or only a very small amount of water, the bulk density is preferably from 250 g/l to 600 g/l.

The support according to the present invention is preferably produced from a silica hydrogel. Consequently, the support preferably has a high SiO₂ content. The silicon content of the support is preferably ≧10% by weight, more preferably ≧15% by weight, even more preferably ≧20% by weight, particularly preferably ≧25% by weight, more particularly preferably ≧30% by weight, especially preferably ≧40% by weight, very particularly preferably ≧50% by weight, based on the total weight of support.

Aluminum can be added to the hydrogel in step b) and/or the slurry based on the finely particulate hydrogel, preferably silica hydrogel, in step c), preferably in the form of compounds selected from the group consisting of Al₂O₃, AlPO₄ and AlOOH. The aluminum content of the support is preferably ≧5% by weight, more preferably ≧10% by weight, even more preferably ≧15% by weight, very preferably ≧20% by weight, particularly preferably ≧25% by weight, very particularly preferably ≧30% by weight, especially preferably ≧40% by weight, most preferably ≧50% by weight, based on the total weight of the support.

Furthermore, zirconium compounds, preferably compounds selected from the group consisting of zirconium hydroxide, zirconium oxide-hydroxide, ZrO₂, ZrO(NO₃)₂, Zr(OR)₄ and Zr(OOCR)₄, where R is preferably selected from the group consisting of substituted or unsubstituted alkyl having from 1 to 20 carbon atoms, e.g. methyl, ethyl, n-propyl, n-butyl, tert-butyl, n-pentyl, n-hexyl, n-heptyl, n-octyl, vinyl, allyl, benzyl and/or phenyl, can be added to the hydrogel in step b) and/or to the slurry based on the finely particulate hydrogel, preferably silica hydrogel, in step c). The zirconium compounds can be milled together with the hydrogel and/or the slurry and/or be milled separately, preferably wet.

The zirconium content of the support is preferably in the range from ≧0.1 % by weight to ≦10% by weight, more preferably in the range from ≧0.5% by weight to ≦5% by weight, even more preferably in the range from ≧1% by weight to ≦4% by weight, particularly preferably in the range from ≧2% by weight to ≦3% by weight, based on the total weight of the support.

It is also possible to add titanium, preferably in the form of compounds selected from the group consisting of titanium hydroxide, titanium oxide-hydroxide, TiO₂, TiO(NO₃)₂, Ti(OR)₄ and Ti(OOCR)₄, where R is preferably selected from the group consisting of substituted or unsubstituted alkyl having from 1 to 20 carbon atoms, e.g. methyl, ethyl, n-propyl, n-butyl, tert-butyl, n-pentyl, n-hexyl, n-heptyl, n-octyl, vinyl, allyl, benzyl and/or phenyl, to the hydrogel in step b) and/or to the slurry based on the finely particulate hydrogel, preferably silica hydrogel, in step c). The titanium compounds can be milled together with the hydrogel and/or the slurry and/or be milled separately, preferably wet. The titanium content of the support is preferably in the range from ≧0.1% by weight to ≦10% by weight, more preferably in the range from ≧0.5% by weight to ≦5% by weight, even more preferably in the range from ≧1% by weight to <4% by weight, particularly preferably in the range from ≧2% by weight to ≦3% by weight, based on the total weight of the support.

The catalyst supports according the present invention are suitable for a variety of applications, for example as supports for hydrogenation catalysts, as supports for dehydrogenation catalysts and/or as supports for fixed-bed catalysts. For example, the catalyst supports according to the present invention are useful for hydrogenation catalysts based on impregnated ruthenium compounds for the hydrogenation of aromatic rings to aliphatic rings in the presence of polar functional groups. The catalyst supports according to the present invention are preferably used for preparing supported catalysts for the polymerization and/or copolymerization of olefins. The supports which can be prepared by the process of the present invention have a high mechanical strength and are particularly suitable for use in fluidized-bed reactors and/or stirred gas-phase reactors.

However, the supports according to the present invention are not restricted to applications in which catalyst compounds are applied. For example, the supports according to the present invention can likewise be suitable for application of substances which have no catalytic activity. Furthermore, the supports according to the present invention can likewise be suitable for use as catalysts in modern organic synthesis and industrial processes. In particular, the supports according to the present invention can themselves be used as catalysts, for example in organic reactions, i.e. the support can display catalytic properties.

The supported catalysts can be prepared, for example, by applying one or more catalyst compounds and optionally activators to a support according to the present invention. Supports according to the present invention are particularly preferably used with a catalyst suitable for the polymerization of olefins. Catalysts which can be used here are particularly preferably catalysts selected from the group consisting of Ziegler-Natta catalysts, Phillips catalysts, preferably catalysts based on chromium oxides, and/or catalyst systems having a uniquely defined active center, viz. single site catalysts, which can comprise a metal complex, for example a metallocene, chromium-, iron-, cobalt-, vanadium-, nickel- and palladium-containing systems, other transition metal systems and/or one or more activator compounds.

Suitable activator compounds and/or cocatalysts can, for example, be selected from the group consisting of aluminum compounds such as cyclic and linear aluminoxanes, for example methylaluminoxane (MAO), electron donor compounds, aluminum alkyls, boranes, boroxins, borates, alkyl compounds of lithium, magnesium or zinc, organosilicon compounds, activator compounds having strongly oxidizing properties and mixtures thereof.

Supports for catalysts can be prepared in high quality by the process of the present invention. A great advantage of the catalyst supports which can be prepared by the process of the present invention is that in preferred embodiments they have an advantageous hardness and compactness despite their porosity. The supports according to the present invention preferably have a low susceptibility to being broken and/or fragility than the supports customary in the prior art.

The advantageous properties of the catalyst supports which can be prepared by the process of the present invention can lead, for example in polymerization reactions using the supports according to the present invention in combination with a known catalyst customary for the polymerization of olefins, to the fines content of the resulting polymer being significantly reduced. The fines content of a polymer is, for the purposes of the present invention, the proportion having a particle size of less than 250 μm, and the proportion of very fine material in a polymer is the proportion having a particle size of less than 125 μm. Surprisingly, the polymers produced using supports which can be prepared according to the present invention have, in preferred embodiments, a surprisingly low proportion of polymer having a particle size of less than 250 μm or 125 μm.

The very low fines contents which can be achieved in polymerization processes when using the supports which can be prepared by the process of the present invention represent a particular advantage of the present invention.

A low fines content of the polymer can lead to a polymerization product having improved properties, for example an improved film grade and/or a low level of specks in the polymer films. A low fines content of the polymer can also lead to significantly improved manageability of the polymerization process.

A further advantage of the supports according to the present invention is that, in preferred embodiments, the bulk density of the resulting polymer is significantly increased when the supports which can be prepared by the process of the present invention are used.

A further important advantage of the supports according to the present invention is, in particularly preferred embodiments, a surprisingly high activity and productivity of the catalysts supported on the supports in the polymerization and copolymerization of olefins.

Advantageously, the supports which can be prepared by the process of the present invention can make it possible to carry out polymerization reactions at a high activity and to give a polymer having a high bulk density.

Catalyst systems comprising catalyst supports which can be prepared according to the present invention can be prepared by applying at least one transition metal and/or at least one transition metal compound to the catalyst support and, if appropriate, activating the metal/metal compound.

To remove impurities, in particular moisture, adhering to the support, the support can be subjected to heat treatment, preferably in the range from 45° C. to 1000° C., more preferably in the range from 100° C. to 750° C., prior to application of the transition metal compound and/or prior to doping. This heat treatment is carried out for from 0.5 hours to 24 hours, preferably from 1 hour to 12 hours. The heat treatment can be carried out in a fixed-bed process, a stirred vessel or a moving-bed process. The pressure conditions depend on the process chosen; in general, heat treatment can be carried out at atmospheric pressure, but it is advantageous to use reduced pressures in the range from 0.1 mbar to 500 mbar, particularly advantageously in the range from 1 mbar to 100 mbar and very particularly advantageously in the range from 2 mbar to 20 mbar. In the case of moving-bed processes, the use of slightly superatmospheric pressure in a range from ≧1 bar to 5 bar, preferably in the range from 1.1 bar to 1.5 bar, is advisable.

Chemical pretreatment of the support material with an alkyl compound, preferably an alkyl compound of aluminum, lithium, zinc, magnesium and/or boron, e.g. Al(R)₃, LiR, ZnR₂, MgR₂, MgR(Hal), BR₃, AlRₙ(X)ₘ or an aluminoxane, where Hal is preferably a halogen atom, X is preferably OR, Cl, Br, where R is preferably an alkyl having from 1 to 12 carbon atoms, more preferably an alkyl having from 1 to 6 carbon atoms and particularly preferably an alkyl having from 1 to 4 carbon atoms, e.g. methyl, ethyl, butyl or isobutyl, and n and m are preferably integers from 0 to 3, is also possible.

Preference is given to applying at least one transition metal and/or at least one compound of a transition metal comprising transition metals selected from the group consisting of Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg, preferably Ti, Zr, Cr, Fe, Ni and Pd, to the support for catalysts.

As transition metal compounds, it is possible to use, for example, classical Ziegler compounds or Ziegler-Natta compounds. Customary catalysts of this type are described, for example, in Ullmann's Encyclopedia of Industrial Chemistry, Vol. A 21, 4th edition 1992, p. 502 ff. Preferred catalysts are described, for example, in U.S. Pat. No. 4,857,613 and in DE-A-19 529 240. Preference is given to compounds based on titanium, classical Phillips catalysts based on chromium oxides, single site catalysts based on metallocenes, known as constrained geometry complexes, nickel and palladium bisimine systems, iron and cobalt pyridinebisimine compounds and/or chromium amides.

Suitable chromium compounds are, for example, chromium trioxide, chromium hydroxide and also soluble salts of trivalent chromium with an organic or inorganic acid, e.g. acetates, oxalates, sulfates or nitrates. Particular preference is given to using salts of acids which on activation are converted essentially into chromium(VI) without leaving a residue, e.g. chromium(III) nitrate nonahydrate. Furthermore, it is likewise possible to use chelate compounds of chromium, e.g. chromium derivatives of β-diketones, β-ketoaldehydes or β-dialdehydes, and/or complexes of chromium, e.g. chromium(III) acetylacetonate or chromium hexacarbonyl, or organometallic compounds of chromium, e.g. bis(cyclopentadienyl)chromium(II), organic chromic(VI) esters or bis(arene)chromium(0).

Doping of the catalyst support with a chromium-containing component is preferably carried out from solution or, in the case of volatile compounds, from the gas phase. For example, the preparation of supported chromium catalysts can be carried out in two steps. In a first step, the support material can firstly be brought into contact with a soluble chromium compound in a suitable solvent and the solvent can subsequently be removed. For this purpose, the support material can be suspended in a solvent or in a solution of the chromium compound. Subsequently, in a second step, the mixture of support and chromium compound can be calcined at high temperatures, preferably at temperatures in the range from 300° C. to 1100° C., preferably in a stream of air or oxygen. The nature of the support material is of great importance here.

The chromium compound is preferably added to the support, but it is also possible to suspend the support in a solution comprising the appropriate chromium compound and evaporate the liquid constituents of the reaction mixture while mixing continually, preferably to maintain a homogeneous mixture. Suitable solvents are, for example, water, alcohols, ketones, ethers, esters and hydrocarbons. The application of a chromium compound is preferably carried out from a 0.05% strength by weight to 15% strength by weight solution of a chromium compound which is converted under the conditions of the activation into chromium trioxide in a C₁-C₄-alcohol, with the respective solvent preferably containing no more than 20% by weight of water. The support can also be loaded without using solvents, for example by mechanical mixing.

The weight ratio of the chromium compounds to the support during loading is preferably in the range from 0.001:1 to 200:1, more preferably in the range from 0.005:1 to 100:1.

The chromium content of the supported catalysts which can be prepared in the process of the present invention by application of at least one chromium compound is preferably, based on the element, from 0.1% by weight to 5% by weight, more preferably from 0.2% by weight to 1.5% by weight, based on the total weight of the supported catalyst. The chromium content based on the element is preferably from 0.3% by weight to 1.0% by weight, more preferably from 0.5% by weight to 0.7% by weight, based on the total weight of the supported catalyst.

The supported catalysts which can be prepared according to the present invention, preferably catalysts of the Phillips type, in particular chromium catalysts, can, if desired, comprise a plurality of transition metals and/or compounds of transition metals.

Preference is given to applying at least one further transition metal and/or at least one further compound of a transition metal, preferably comprising transition metals selected from the group consisting of Ti, Zr, Hf, V, Cr, Fe, Co, Ni, Zn and Pd, to the catalyst support which has been modified with at least one transition metal and/or compound of a transition metal.

Catalyst systems of the Ziegler-Natta type can comprise at least one compound of a transition metal, for example titanium and/or vanadium, and a compound of magnesium and/or an internal electron donor compound and also cocatalysts and/or an aluminum compound and, if desired, a further external electron donor compound.

According to the present invention, it is possible to use either pure transition metal compounds or mixtures of various transition metal compounds for modifying the support, with both mixtures of metallocenes or Ziegler-Natta compounds among one another and mixtures of metallocenes with Ziegler-Natta compounds being able to be advantageous. Likewise, mixtures of metallocenes, Ziegler-Natta compounds and/or chromium compounds may also be useful.

In the preparation of a supported catalyst, preference is also given to applying at least one complex of a transition metal, preferably a metallocene compound, preferably a compound comprising a transition metal selected from the group consisting of Ti, Zr, Hf, V, Cr, Fe, Co, Ni, Zn and Pd, to the support for catalysts.

Preference is given to transition metal complexes which have two aromatic ring systems bridged to one another as ligands. It is possible to use, for example, bridged, preferably ansa-bridged, and also unbridged metallocene complexes with π ligands such as cyclopentadienyl, indenyl or fluorenyl ligands which are preferably substituted, with both symmetrical and unsymmetrical complexes of central metals being possible. Metallocene compounds which can be used preferably comprise a transition metal selected from the group consisting of Ti, Zr, Hf, V, Cr, Fe, Co, Ni, Zn and Pd, with titanium and especially zirconium being particularly preferred.

Preference is given to zirconocene or titanocene complexes in the oxidation state +4, particularly preferably zirconium complexes in the oxidation state +4. Preferred zirconium compounds are known, for example, from DE 197 16 239 A1. Further preferred compounds, in particular single site systems, are known, for example, from Chem. Rev., 2000, Vol. 100(4), pp. 1167-1682 and/or V. C. Gibson et al., Chem. Rev., 2003, 103, 283-315.

Particular preference is given to zirconium compounds selected from the group consisting of bis(cyclopentadienyl)zirconium dichloride, bis(pentamethylcyclopentadienyl)zirconium dichloride, bis(methylcyclopentadienyl)zirconium dichloride, bis(ethylcyclopentadienyl)zirconium dichloride, bis(n-butylcyclopentadienyl)zirconium dichloride, bis(trimethylsilylcyclopentadienyl)zirconium dichloride, the corresponding dimethylzirconium compounds, ethylenebis(4,5,6,7-tetrahydro-1-indenyl)zirconium dichloride and/or bis(1,3-dimethylcyclopentadienyl)zirconium dichloride, with the compound bis(n-butylcyclopentadienyl)zirconium dichloride, n-BuMeCp₂ZrCl₂, being very particularly preferred.

The zirconium content of the supported metallocene catalysts prepared by the process of the present invention is preferably from 0.01% by weight to 2% by weight, preferably from 0.03% by weight to 1% by weight and particularly preferably from 0.05% by weight to 0.5% by weight, based on the total weight of the supported catalyst.

It is also possible to use mixtures of various metallocene compounds or mixtures of various catalysts in the polymerization.

Activation of the transition metals or compounds of transition metals applied to supports which can be prepared according to the present invention is, if appropriate, carried out as a function of the transition metals and/or compounds used.

The catalyst support which has been modified with at least one transition metal and/or at least one compound of a transition metal is advantageously activated by thermal activation, preferably calcination and/or oxidation, halogenation, preferably fluorination, and/or addition of at least one activator compound.

Activation of the catalyst support which has been modified with at least one transition metal and/or at least one compound of a transition metal can be carried out in a customary fashion.

Activation of a catalyst modified with chromium or a chromium compound is preferably carried out under conditions which are selected so that the chromium in the finished catalyst is mostly present in the hexavalent state.

Thermal activation of a catalyst which has, for example, been modified with chromium or a chromium compound is preferably carried out by heating in an oxidizing atmosphere, but can also be carried out in a nonoxidizing atmosphere, for example in inert gas, nitrogen or a reducing gas such as CO or hydrogen or under reduced pressure.

In preferred embodiments, a catalyst support modified with at least chromium or a chromium compound is activated by:
a) halogenation; and/or
b) thermal activation in an oxidizing, reducing and/or.neutral atmosphere; and/or
c) renewed thermal activation in a reducing atmosphere,
   with thermal activation preferably being carried out in the range from 400° C. to 1000° C., more preferably in the range from 450° C. to 900° C. A catalyst support modified with at least chromium or a chromium compound is preferably activated by halogenating it and thermally activating it in an oxidizing, reducing and/or neutral atmosphere and subsequently activating it again in a reducing atmosphere.

The thermal activation is preferably carried out in a gas stream comprising water-free oxygen in a concentration of more than 10% by volume, e.g. in air, at from 400° C. to 1100° C., preferably from 500° C. to 900° C. The activation can be carried out in a moving bed and/or in a stationary bed, or in a fluidized bed, preferably under reduced pressure. Thermal activation is preferably carried out in fluidized-bed reactors.

Catalysts modified with chromium or a chromium compound can also be doped with fluoride. Doping with fluoride can be carried out during the preparation of the support, during application of the transition metal or the transition metal compound or during activation. In a preferred embodiment of the preparation of the supported catalyst, doping is carried out during application of the transition metal or the transition metal compound, with a fluorinating agent being applied together with the desired chromium component, for example by coimpregnation of the support with a solution of the fluorinating agent and the desired chromium compound.

In a further, preferred embodiment, doping with fluorine is carried out subsequent to the application of the chromium during the activation step of the process of the present invention. Fluoride doping is particularly preferably carried out together with the activation at from 400° C. to 900° C. in air. A suitable apparatus for this purpose is, for example, a fluidized-bed activator.

Fluorinating agents are preferably selected from the group consisting of CIF₃, BrF₃, BrF₅, (NH₄)₂SiF₆ (ammonium hexafluorosilicate), NH₄BF₄, (NH₄)₂AlF₆, NH₄HF₂, (NH₄)₃PF₆, (NH₄)₂TiF₆ and (NH₄)₂ZrF₆. Preference is given to using fluorinating agents selected from the group consisting of (NH₄)₂SiF₆, NH₄BF₄, (NH₄)₂AlF₆, NH₄HF₂, (NH₄)₃PF₆. Particular preference is given to using (NH₄)₂SiF₆.

The fluorinating agent is generally used in an amount in the range from 0.5% by weight to 10% by weight, preferably in the range from 0.5% by weight to 8% by weight, particularly preferably in the range from 1% by weight to 5% by weight, very particularly preferably in the range from 1% by weight to 3% by weight, based on the total mass of the catalyst used. Preference is given to using from 2% by weight to 2.5% by weight, based on the.total mass of the catalyst used. The properties of the polymers produced can be varied as a function of the amount of fluoride in the catalyst.

Fluorination of the catalyst system can advantageously lead to a narrower molecular weight distribution of the polymers obtainable in a polymerization than in the case of a polymerization using a nonfluorinated catalyst.

Some metallocene complexes which can be used for preparing a supported catalyst according to the present invention have little or no polymerization activity and can be brought into contact with an activator in order to develop a good polymerization activity. For this reason, processes for the polymerization and/or copolymerization of olefins are carried out in the presence of metallocene complex(es) and, if appropriate, in the presence of at least one activator compound.

Suitable activator compounds are, for example, those of the aluminoxane type, alkyl compounds of lithium, magnesium, boron, for example B(C₂H₅)₃, and/or zinc, compounds such as aluminum alkyls, alkylaluminum alkoxides, alkylaluminum hydrides and/or AlR₂Hal, where Hal is a halogen atom, R is preferably an alkyl having from 1 to 12 carbon atoms, more preferably an alkyl having from 1 to 6 carbon atoms and particularly preferably an alkyl having from 1 to 4 carbon atoms, e.g. methyl, ethyl, butyl or isobutyl. Combinations of various activators can likewise be used.

Supported catalysts which can be prepared by the process of the present invention are particularly useful for the polymerization and/or copolymerization of olefins.

Supported catalysts which can be prepared by the process of the present invention are particularly useful for the polymerization and/or copolymerization of olefins in the presence of supported catalysts as claimed in the claims pertaining to catalysts.

The catalyst systems which can be prepared according to the present invention can be used in known polymerization processes such as high-pressure polymerization processes, suspension polymerization processes, solution polymerization processes and/or gas-phase polymerization. Suitable reactors are, for example, continuous stirred tank reactors, loop reactors, fluidized-bed reactors or horizontally or vertically stirred powder-bed reactors, tube reactors or autoclaves. Of course, the reaction can also be carried out in a cascade made up of a plurality of reactors connected in series. The residence time depends critically on the reaction conditions selected in each case. It is usually in the range from 0.2 hour to 20 hours, mostly in the range from 0.5 hour to 10 hours. Advantageous pressures and temperatures for the polymerization reactions can vary within a wide range and are preferably in the range from −20° C. to 300° C. and/or in the range from 1 bar to 4000 bar, depending on the polymerization method.

In high-pressure polymerization processes, the pressure is preferably in the range from 1000 bar hto 4000 bar, more preferably in the range from 2000 bar to 3500 bar, and the temperature is preferably in the range from 200° C. to 280° C., more preferably in the range from 220° C. to 270° C. In solution polymerization processes, the temperature is preferably in the range from 110° C. to 250° C., more preferably in the range from 120° C. to 160° C. In solution polymerization processes, the pressure is preferably in the region of 150 bar. In suspension polymerizations, the polymerization is usually carried out in a suspension medium, preferably an alkane. The polymerization temperatures in suspension polymerization processes are preferably in the range from 50° C. to 180° C., more preferably in the range from 65° C. to 120° C., and the pressure is preferably in the range from 5 bar to 100 bar.

The order of addition of the components in the polymerization is generally not critical. It is possible to place the monomer in the reactor at the beginning and subsequently add the catalyst, and also to place the catalyst system together with a solvent in the reactor first and subsequently add the monomer.

If desired, antistatics can be added in the polymerization. Preferred antistatics are, for example, ZnO and/or MgO, which are preferably used in amounts of from 0.1% by weight to 5% by weight, based on the total weight of the catalyst mixture. The water content of the ZnO or MgO is preferably less than 0.5% by weight, more preferably less than 0.3% by weight, based on the total mass in each case. An example of a commercial product which can be used is Stadis 450, obtainable from DuPont. Antistatics which can be used are, for example, known from EP 229 368, U.S. Pat. No. 5,026,795 and U.S. Pat. No. 4,182,810.

In addition, further customary additives, for example stabilizers and/or fillers, can be added in the polymerization.

The supported catalysts which can be prepared by the process of the present invention are suitable for the polymerization and/or copolymerization of unsaturated compounds, for example nonconjugated and conjugated dienes, polar monomers or vinylaromatic compounds.

The supported catalysts which can be prepared by the process of the present invention can be advantageously used for the polymerization and/or copolymerization of ethene and α-olefins having from 3 to 12 carbon atoms. Preference is given to monounsaturated and/or polyunsaturated olefins, preferably 1-alkenes, especially those selected from the group consisting of ethene, propene, butene, pentene, hexene, heptene, octene, nonene and/or decene, more preferably ethene, propene, 1-butene, 1-pentene, 1-hexene, 1-heptene, 1-octene, 1-nonene and/or 1-decene, particularly preferably ethene, propene, 1-butene, 1-pentene, 1-hexene, 1-heptene and/or 1-octene. Ethene, propene, 1-butene, 1-pentene, 1-hexene, 1-heptene and/or 1-octene, in particular, can in the liquefied or liquid state also form the solvent for the polymerization and/or copolymerization reaction.

The molar mass of the polymers can be controlled by addition of regulators customary in polymerization engineering, for example hydrogen, and can be set over a wide range. It is also possible to make concomitant use of, for example, inert solvents such as toluene or hexane, inert gases such as nitrogen or argon or relatively small amounts of polymer.

Catalyst systems comprising metallocene compounds preferably further comprise a compound capable of forming metallocenium ions. Suitable compounds capable of forming metallocenium ions are strong, uncharged Lewis acids, ionic compounds having Lewis-acid cations and ionic compounds containing Brönsted acids as cation. Particularly useful compounds capable of forming metallocenium ions are open-chain or cyclic aluminoxane compounds.

The polymerization and/or copolymerization using supported catalyst which can be prepared according to the present invention is, if appropriate, preferably carried out in the presence of at least one activator compound. The activator compound is preferably an organometallic compound, preferably a compound of a metal selected from the group consisting of B, Al, Zn and Si.

Catalyst systems comprising metallocene compounds preferably comprise, as a activator compounds, organometallic compounds of a (semi)metal of main group 3 or 4 of the Periodic Table, also referred to as “cocatalysts”, preferably compounds of the elements boron or aluminum. Halide-free compounds are preferred. The organic radicals of compounds are preferably selected from the group consisting of the radicals alkyl, alkenyl, aryl, alkaryl, aralkyl, alkoxy, aryloxy, alkaryloxy and aralkoxy and fluorine-substituted derivatives.

Particularly useful activator compounds are, for example, those of the aluminoxane type, preferably aluminoxanes having alkyl groups on the aluminum, e.g. methylaluminoxane, ethylaluminoxane, propylaluminoxane, isobutylaluminoxane, phenylaluminoxane or benzylaluminoxane, in particular methylaluminoxane, MAO. Suitable aluminoxane preparations are commercially available. It is assumed that these are mixtures of cyclic and linear compounds. The cyclic aluminoxanes can be represented by the formula (RkAIO)ₛ and the linear aluminoxanes can be represented by the formula Rk(RkAlO)ₛAlRk₂, where s indicates the degree of oligomerization and is from about 1 to 50. Advantageous aluminoxanes consist essentially of aluminoxane oligomers having a degree of oligomerization of from about 1 to 30. Rk is preferably an alkyl having from 1 to 12 carbon atoms, more preferably an alkyl having from 1 to 6 carbon atoms and particularly preferably an alkyl having from 1 to 4 carbon atoms, e.g. methyl, ethyl, butyl or isobutyl.

Apart from the aluminoxanes, it is also possible to use activator components of the type employed in cationic activation of metallocene complexes. Such activator components are known, for example, from EP-B1-0468537 and EP-B1-0427697. Particularly useful activator compounds are borans, boroxins or borates, for example trialkylborane, triarylborane, trimethylboroxin, dimethylanilinium tetraarylborate, trityl tetraarylborate, dimethylanilinium boratabenzenes or trityl boratabenzenes. Particular preference is given to using boranes or borates which bear at least two perfluorinated aryl radicals. Particularly advantageous activator compounds are compounds selected from the group consisting of aluminoxane, dimethylanilinium tetrakispentafluorophenylborate, trityl tetrakispentafluorophenylborate and trispentafluorophenylborane.

Activator compounds having strongly oxidizing properties can also be used, e.g. silver borates, in particular silver tetrakispentafluorophenylborate, or ferrocenium borates, in particular ferrocenium tetrakispentafluorophenylborate or ferrocenium tetraphenylborate.

Further activator components which can be used are compounds such as aluminum alkyls, preferably trialkylaluminum compounds such as trimethylaluminum, triethylaluminum, tripropylaluminum, triisopropylaluminum, triisobutylaluminum, tributylaluminum, dimethylaluminum chloride, dimethylaluminum fluoride, methylaluminum dichloride, methylaluminum sesquichloride, diethylaluminum chloride or aluminum trifluoride. The reaction products of aluminum alkyls with alcohols can also be used.

Further activator compounds which can be used are alkyl compounds of lithium, magnesium or zinc, e.g. methylmagnesium chloride, methylmagnesium bromide, ethylmagnesium chloride, ethylmagnesium bromide, butylmagnesium chloride, dimethylmagnesium, diethylmagnesium, dibutylmagnesium, methyllithium, ethyllithium, methylzinc chloride, dimethylzinc or diethylzinc. Furthermore, olefin complexes of rhodium or nickel can likewise be suitable activators.

Combinations of various activators can likewise be used. This is known, for example, in the case of metallocenes where boranes, boroxins (WO-A-93/16116) and borates are often used in combination with an aluminum alkyl. A combination of various activator components with various metallocenes is generally also possible.

The amount of activator compounds which can be used depends on the type of activator. In general, aluminoxanes have to be used in significant molar excesses and the molar ratio of metallocene complex to activator compound can be from 1:0.1 to 1:10 000, preferably from 1:1 to 1:2000, and particularly preferably from 1:10 to 1:1000. The molar ratio of metallocene complex to dimethylanilinium tetrakispentafluorophenylborate, trityl tetrakispentafluorophenylborate or tripentafluorophenylborane is preferably in the range from 1:1 to 1:20, more preferably in the range from 1:1 to 1:15 and particularly preferably in the range from 1:1 to 1:5, and that to methylaluminoxane is preferably in the range from 1:1 to 1:2000 and particularly preferably in the range from 1:10 to 1:1000. Since many of the activators such as aluminum alkyls are simultaneously used for removing catalyst poisons (i.e. as scavengers), the amount used depends on the contamination of the remainder of the starting materials. A person skilled in the art will determine the optimum amount empirically.

The metallocene compound, particularly preferably a zirconium compound, is preferably brought into contact with the activator compound prior to application to the support. Preference is given to mixing a usable zirconium compound with a solution of MAO in a suitable organic solvent, for example toluene, prior to application to the support and subsequently adding a mixture comprising zirconium compound, MAO and solvent to the support.

The metallocene complexes and the optional activator compounds can be brought into contact with the support either successively or simultaneously, preferably in an inert solvent which can be removed by filtration or evaporation after immobilization of the metallocene complex. Thus, the support can firstly be brought into contact with the activator compound or compounds or the support can firstly be contacted with the transition metal compound(s). The activation of the transition metal compound(s) with one or more activator compound(s) before it/they is/are brought into contact with the support is also possible. It can also be advantageous to carry out a preactivation using one or more activator compounds prior to addition of the olefin to be polymerized and to carry out a further addition of the same or different activator compounds after this mixture has been brought into contact with the olefin. A further way of achieving the immobilization is prepolymerization of the catalyst system with or without prior application to the support.

The polymerization can be carried out batchwise, for example in stirring autoclaves, or continuously, for example in tube reactors, preferably in loop reactors, in particular by means of the Phillips PF process as described in U.S. Pat. No. 3,242,150 and U.S. Pat. No. 3,248,179. Semicontinuous processes in which all components are mixed and further amounts of monomers or monomer mixtures are metered in during the polymerization can also be used.

Among the polymerization processes mentioned, preference is given to gas-phase polymerizations, in particular in gas-phase fluidized-bed reactors or stirred gas phases, solution polymerizations and suspension polymerizations, in particular in loop reactors and stirred tank reactors. The polymerization and/or copolymerization is particularly preferably carried out as a gas-phase fluidized-bed process and/or a suspension process. The gas-phase polymerization can also be carried out in a condensed, supercondensed or supercritical phase. Polymerization processes of different types or of the same type can also, if desired, be connected in series so as to form a polymerization cascade. Furthermore, an additive, e.g. hydrogen, can be used in the polymerization processes to regulate the polymer properties. Hydrogen can, if desired, be used as molecular weight regulator.

It is generally possible to use supported catalysts having particle sizes in the range from 1 μm to 400 μm, preferably in the range from 40 μm to 200 μm. In fixed-bed reactors, preference is given to supported catalysts having particle sizes in the range from 0.5 mm to 10 mm.

Polymerizations and/or copolymerizations in the gas-phase fluidized-bed process are preferably carried out using supported catalysts having a mean particle size of the catalyst particles in the range from 30 μm to 300 μm, preferably in the range from 40 μm to 100 μm, particularly preferably in the range from 40 μm to 80 μm.

Polymerizations and/or copolymerizations in the suspension process are preferably carried out using supported catalysts having a mean particle size of the catalyst particles in the range from 30 μm to 350 μm, preferably in the range from 40 μm to 100 μm.

In particular embodiments, the proportion of discharged polymer having a particle size in the range from >0 μm to ≦125 μm produced in a polymerization and/or copolymerization using the supported catalysts which can be prepared according to the present invention is advantageously ≦15% by weight, preferably ≦5% by weight, particularly preferably ≦3% by weight, very particularly preferably in the range from 0.3% by weight to 2% by weight, based on the total weight of the product.

In a polymerization and/or copolymerization in the gas-phase fluidized-bed process using the supported catalysts which can be prepared according to the present invention, the proportion of discharged polymer having a particle size in the range from >0 μm to ≦125 μm is advantageously ≦13% by weight, preferably ≦10% by weight, particularly preferably ≦5% by weight, very particularly preferably ≦3% by weight, based on the total weight of the product. In a polymerization and/or copolymerization in the suspension process using the supported catalysts which can be prepared according to the present invention, the proportion of discharged polymer having a particle size in the range from >0 μm to ≦125 μm is preferably ≦10% by weight, more preferably ≦5% by weight, particularly preferably ≦3% by weight, very particularly preferably in the range from 0.3% by weight to 1.5% by weight, based on the total weight of the product.

Furthermore, in a polymerization and/or copolymerization using the supported catalysts which can be prepared according to the present invention, the proportion of discharged polymer having a particle size in the range from >0 μm to ≦250 μm is, in preferred embodiments, advantageously ≦30% by weight, preferably ≦20% by weight, more preferably ≦15% by weight, particularly preferably ≦10% by weight and very particularly preferably in the range from 0.5% by weight to 5% by weight, based on the total weight of the product.

In a polymerization and/or copolymerization, in particular of 1-alkene, in the gas-phase fluidized-bed process using the supported catalysts which can be prepared according to the present invention, the proportion of discharged polymer having a particle size in the range from >0 μm to ≦250 μm can advantageously be ≦30% by weight, preferably ≦20% by weight, more preferably ≦15% by weight, particularly preferably ≦10% by weight and very particularly preferably in the range from 0.5% by weight to 5% by weight, based on the total weight of the product. In a polymerization and/or copolymerization in the suspension process using the supported catalysts which can be prepared according to the present invention, the proportion of polymer having a particle size in the range from >0 μm to ≦250 μm is preferably ≦20% by weight, more preferably ≦15% by weight, even more preferably ≦10% by weight, particularly preferably ≦8% by weight, based on the total weight of the product.

The very low fines contents which can be achieved in polymerization processes using the supports which can be prepared by the process of the present invention represent a particular advantage of the present invention. A lower fines content in the polymer can lead to a polymerization product having improved properties, for example an improved film grade and/or a lower level of specks in the polymer films. A lower fines content in the polymer can also lead to significantly better manageability of the polymerization process. A lower fines content in the polymer can advantageously prevent or at least significantly reduce the formation of lumps, deposits on walls and agglomerates in the reactor, which, particularly in gas-phase processes, block the discharge lanes and can lead to shutdown and cleaning of the plant.

In particularly preferred embodiments, the supported catalyst systems which can be prepared according to the present invention make it possible to prepare polymers and/or copolymers, in particular ones which can be prepared from 1-alkene, having a high bulk density and a low proportion of fines and/or very fine material. For the purposes of the present invention, very fine material is a polymer which has a particle size of less than 125 μm.

In a polymerization and/or copolymerization using the supported catalysts which can be prepared according to the present invention, in particular a polymerization and/or copolymerization of 1-alkene, the bulk density of the polymer is advantageously in the range from 300 g/l to 600 g/l, preferably in the range from 400 g/l to 550 g/l, particularly preferably in the range from 450 g/l to 530 g/l.

In polymerizations and/or copolymerizations in the gas-phase fluidized-bed process and/or suspension process using the supported catalysts which can be prepared according to the present invention, in particular polymerizations and/or copolymerizations of 1-alkene, the bulk density of the polymer is preferably in the range from 300 g/l to 600 g/l, more preferably in the range from 400 g/l to 550 g/l, particularly preferably in the range from 450 g/l to 530 g/l.

A further great advantage in particularly preferred embodiments of the supports according to the present invention is a surprisingly high activity and productivity of the catalysts supported on the supports in the polymerization and copolymerization of olefins.

A particular advantage of the supported catalysts which can be prepared by the process of the present invention is, in very particularly preferred embodiments, a high productivity combined with a low fines content.

A further advantage of the supported catalysts which can be prepared by the process of the present invention is that they can, in preferred embodiments, lead to a high molecular weight of the polymer product. This can be controlled as a function of the catalyst and the polymerization conditions.

The use of the supported catalysts prepared according to the present invention makes it possible to obtain polyolefins which have an excellent property profile. In particular, the copolymerization of ethene with α-olefins using supported catalysts which can be prepared according to the present invention can lead to polyethylene having a low fines content and a narrow distribution of the bulk density. Due to this advantageous combination of properties, these polyethylenes have excellent processing behavior.

Supported catalysts which can be prepared according to the present invention can be used to prepare polymers and/or copolymers of olefins. The use of the term polymerization encompasses both polymerization and oligomerization, i.e. oligomers and polymers having molecular weights in the range from about 56 to 4000000 can be produced.

Owing to their good mechanical properties, the polymers and copolymers of olefins prepared using supported catalysts which can be prepared according to the present invention are especially suitable for the production of films, fibers and moldings comprising polymers of olefins according to the present invention as substantial or exclusive components.

The following example illustrates the invention.

General Preliminary Remarks:

Analysis:

The particle size of the hydrogel particles was determined by sieve analysis using a Mastersizer S long bed Ver. 2.15, Malvern Instruments GmbH, using the following system parameters: focal length 300RF mm, scattering model 3SSD, path length 2.40 mm, module MS17.

To determine the mean particle diameter of the support particles, the particle size distribution of the support particles was measured by Coulter counter analysis in accordance with ASTM Standard D 4438 and the volume-based mean (median) was calculated therefrom.

The pore volume was determined by means of mercury porosimetry in accordance with DIN 66133.

The determination of the surface area, the pore radius and the pore volume of the support particles is carried out by means of nitrogen adsorption using the BET technique (S. Brunauer et al., Journal of the American Chemical Society, 60, p. 209-319, 1929).

The determination of the silicon and aluminum content and of the metal content of the support particles and the catalyst was carried out by atomic emission spectroscopy using an inductively coupled plasma (ICP-AES).

The viscosity of the polymers (Staudinger index η) was determined in accordance with ISO 1628 (at 135° C.; 0.001 g/ml in decalin).

The polymer density was determined in accordance with ISO 1183.

The determination of the bulk density of the polymer powder was carried out in accordance with DIN 53466.

The determination of the poured density of the polymer powder was carried out in accordance with DIN 53468.

The HLMFR (high load melt flow rate) was determined in accordance with ISO 1133 at 190° C. under a load of 21.6 kg (190°/21.6 kg).

The MFR (melt flow rate) was determined in accordance with ISO 1133 at 190° C. under a load of 2.16 kg (190° C./2.16 kg).

The determination of the sieve distribution and the particle size distribution of the polymer powder was carried out in accordance with DIN 53477, version 1992-1, “Prüfung von Kunststoffen, Trockensiebanalyse”.

The determination of the molar mass distribution was carried out by means of high-temperature gel permeation chromatography using a method based on DIN 55672 under the following conditions: solvent: 1,2,4-trichlorobenzene, flow: 1 ml/min, temperature: 140° C., calibration using PE standards on a Waters 150 C.

Unless indicated otherwise, the polymerization was carried out with exclusion of air and moisture.

### EXAMPLES

1. Preparation of the Support

To prepare the hydrogel, a mixing nozzle, for example as described in DE-A 2103 243, having the following data was used: the diameter of the cylindrical mixing chamber formed by a plastic hose was 14 mm, and the length of the mixing space including the after-mixing section was 350 mm. Close to the inlet end of the mixing chamber, whose inlet end face was closed, there was a tangential inlet hole having a diameter of 4 mm for the mineral acid. Four further holes which likewise had a diameter of 4 mm and the same inlet direction for the water glass solution followed at intervals of 30 mm, measured in the longitudinal direction of the mixing chamber. The ratio of length to diameter for the primary mixing zone was therefore about 10:1. In the subsequent secondary mixing zone, this ratio was 15. As spray nozzle, a flattened, slightly kidney-shaped piece of tube was pushed over the exit end of the plastic hose.

This mixing apparatus was supplied with 325 l/h of 33 percent strength by weight of sulfuric acid at 20° C. and an operating pressure of about 3 bar and with 1 100 l/h of water glass solution, which can be prepared from water glass containing 27% by weight of SiO₂ and 8% by weight of Na₂O by dilution with water, having a density of 1.20 kg/l and a temperature of likewise 20° C. and likewise under a pressure of about 3 bar. In the mixing chamber lined with the plastic hose, an unstable hydrosol having a pH of from 7 to 8 was formed as neutralization progressed and this remained for about a further 0.1 s in the after-mixing zone to achieve complete homogenization before it was sprayed into the atmosphere as a fan-shaped liquid jet through the nozzle. During its flight through the air, the jet broke up into individual droplets which as a result of the surface tension assumed a substantially spherical shape and solidified within about one second to form spherical hydrogel particles during their flight. The hydrogel particles had a smooth surface, were clear and had a solids content of about 17% by weight, calculated as SiO₂.

The hydrogel particles had the following particle size distribution: from 8% by weight to 15% by weight in the range >8 mm, from 30% by weight to 50% by weight in the range from 6 mm to 8 mm, from 20% by weight to 40% by weight in the range from 4 mm to 6 mm and from 5% by weight to 20% by weight in the range <4 mm.

The hydrogel particles were collected in a scrubbing tower which was filled virtually completely with hydrogel particles and in which the spheres were immediately washed free of salts without aging by means of weakly ammoniacal water at about 50° C. in a continuous countercurrent process.

Hydrogel spheres up to 20 mm were used. The solids contents of 5 equal batches of the washed silica hydrogel were each brought to about 10% by weight, calculated as SiO₂, by means of deionized water. Batches 1 to 5 of the hydrogel were each precomminuted separately in a commercial mill. Batches 1 to 5 of the hydrogel were subsequently milled very finely separately from one another in a commercial stirred ball mill. The particle sizes obtained for batches 1 to 5 are shown in table 1. Here, ×10, ×50, ×90 are the particles sizes for which 10% by volume, 50% by volume and 90% by volume, respectively, of the hydrogel particles, based on the total volume of the particles, are smaller than the indicated size.

TABLE I

| | ×10 | ×50 | ×90 | Solids content |
|---|---|---|---|---|
| | μm | μm | μm | [% by weight] |
| Batch 1 | 1.86 | 5.46 | 13.63 | 10.64 |
| Batch 2 | 2.07 | 6.28 | 15.74 | 10.3 |
| Batch 3 | 2.06 | 6.24 | 15.75 | 10.78 |
| Batch 4 | 2.13 | 6.39 | 16.15 | 10.69 |
| Batch 5 | 2.22 | 6.6 | 16.71 | 11.14 |

1.1% by weight, based on the total solids content, of hydroxymethylcellulose (Walocel, obtainable from Wolff) were added to batch 1 of the finely particulate silica hydrogel from step b). 0.5% by weight, based on the total solids content, of hydroxymethylcellulose (Walocel, obtainable from Wolff) and AlOOH calculated as 6% by weight of Al₂O₃, based on the total solids content, were added to batch 2. AlOOH calculated as 6% by weight of Al₂O₃, based on the total solids content, was added to batch 3. AlOOH calculated as 12% by weight of Al₂O₃, based on the total solids content, was added to batch 4. AlOOH calculated as 18% by weight of Al₂O₃, based on the total solids content, was added to batch 5. The solids content of the slurries was in each case set to about 8% by weight, based on the total weight, by means of water.

The slurries of batches 1 to 5 were spray dried. The spray-dried batches were in each case sieved to <0.4 mm. The support particles of all batches had a surface area in the range from 400 m²/g to 500 m²/g, a pore volume in the range from 70 Å to 110 Å and a pore volume in the range from 0.800 ml/g to 1.200 ml/g. A particle size analysis by means of a Coulter counter indicated that the proportion of particles of all batches having a size of <20.2 μm was less than 2.0% by volume and the proportion of particles having a size of <32 μm was less than 20% by volume, based on the total volume of the particles. The mean particle size was in the range from 40 μm to 70 μm.

2. Polymerization Examples Using Chromium Catalysts

2.1 Application of the Chromium Compound

240 g of Cr(NO₃)₃.9 H₂O dissolved in a total of 4 l of methanol were in each case added to 3000 g of each of the supports of batches 1 to 5 and the suspensions were stirred on a rotary evaporator for 30 minutes at room temperature. The methanol was subsequently taken off at 80° C. under reduced pressure and the chromium-laden catalyst precursors were dried. The chromium content was in each case 1% by weight of chromium, based on the total weight of the catalyst.

2.2 Activation and Doping

Activation of the chromium-laden supports of batches 1 to 5 was carried out at 550° C. 2.5% by weight of ammonium hexafluorosilicate (ASF), based on the total mass of the catalyst, were added. To activate the catalyst precursor, it was heated at 350° C. for 1 hour, held at this temperature for 1 hour, subsequently heated to 550° C., held at this temperature for 2 hours and subsequently cooled, with cooling at below 350° C. being carried out under N₂.

2.3 Polymerization

The polymerizations were carried out as suspension polymerizations in isobutane in a 0.2 m³ PF loop reactor. Five experiments using catalysts prepared according to the present invention as described under 2.1 and 2.2 were carried out. The melt flow rate and the density were adjusted via the hexene concentration or ethene concentration. The polymerizations were carried out at reactor temperatures of 100° C.-105° C. The reactor pressure was 39 bar. The polymerization conditions are summarized in table II.

2.4 Comparative Experiment

The catalyst preparation and polymerization were carried out as described under 2.1 to 2.3, except that a commercially available spray-dried support of the type ES 70X, obtainable from Inneos-Silicas, was used in place of the support according to the present invention.

Table II shows the reactor conditions and the polymer analysis for the examples according to the present invention and the comparative experiment.

TABLE II

| | | | | | | Comparative |
|---|---|---|---|---|---|---|
| | Example 1 | Example 2 | Example 3 | Example 4 | Example 5 | example |
| T_{pol.} [° C.] | 103 | 101.5 | 104 | 104 | 103.7 | 103 |
| Ethene | 14.37 | 16.31 | 15.74 | 16.09 | 15.73 | 16 |
| [% by vol.] | | | | | | |
| Hexene | 0.42 | 0.48 | 0.54 | 0.56 | 0.55 | 0.55 |
| [% by vol.] | | | | | | |
| Output [kg/h] | 33 | 32 | 33 | 32 | 33 | 34 |
| P/C | 6700 | 3300 | 8000 | 6580 | 5050 | 3356 |
| [g of PE/g of cat.] | | | | | | |
| HLMFR [g/10 min] | 1.9 | 2.05 | 1.8 | 1.8 | 1.8 | 1.9 |
| η [dl/g] | 5.21 | 5.3 | 5.4 | 4.68 | 5.04 | 4.45 |
| Density [g/cm³] | 0.9510 | 0.9508 | 0.9496 | 0.9496 | 0.9483 | 0.9500 |
| Bulk density [g/l] | 492 | 505 | 501 | 493 | 495 | 554 |
| <125 μm | 0.51 | 1.3 | 0.63 | 0.66 | 0.81 | 6.41 |
| [% by wt] | | | | | | |
| <250 μm | 3.09 | 8.1 | 4.9 | 5.22 | 6.69 | 19.56 |
| [% by wt.] | | | | | | |
| <500 μm | 23.01 | 41.4 | 34.6 | 38.79 | 48.06 | 45.34 |
| [% by wt.] | | | | | | |
| <1.0 mm | 91.39 | 97.5 | 94.7 | 96.56 | 97.99 | 91.11 |
| [% by wt.] | | | | | | |
| <2.0 mm | 99.83 | 99.9 | 99.8 | 99.72 | 99.76 | 99.94 |
| [% by wt.] | | | | | | |
| d′ [μm] | 0.75 | 0.65 | 0.69 | 0.67 | 0.61 | 0.65 |

Abbreviations used:
P/C: g of PE/g of catalyst, productivity
HLMFR: high load melt flow rate (190° C./21.6 kg)
η: viscosity, Staudinger index
d′: mean particle size

As can be seen from the examples in table II, the amount of polymer product having a size of <125 μm and <250 μm in the examples according to the present invention was in the range specified according to the present invention and was significantly lower than in the comparative example.

3. Polymerizations Using Supported Metallocene Catalysts

3.1 Pretreatment of the Supports

Supports from batches 1 to 5 were heated at 600° C. for 6 hours in a fixed-bed process.

3.2 Application of a Zirconocene Compound

0.5 mmol of nBuMeCp₂ZrCl₂ were mixed with 60 mmol of a 30% MAO solution in toluene (obtainable from Albemarle) and the mixture was stirred for 45 minutes. The AI:Zr ratio was 120:1. This solution was subsequently added dropwise to 10 g of the pretreated supports, the supports were stirred for another 45 minutes and the laden support was subsequently dried to constant weight. The loading was 50 μmol of metallocene per g of support calculated as SiO₂.

3.3 Polymerization

The polymerizations were carried out in a 1 liter autoclave which had been made inert with nitrogen. 150 g of polyethylene powder were in each case placed in the autoclave at 70° C. 14.5 ml of heptane and 125 mg of IPRA (obtainable from Witco) (50 mg per ml) in heptane were added thereto and the mixture was stirred for 5 minutes. Nine experiments were carried out using the supports according to the present invention, with the nBuMeCp₂ZrCl₂ metallocene catalyst being added as a solid and the catalyst container being rinsed with 2 ml of heptane. The reactor was subsequently closed and stirred for 10 minutes. It was subsequently pressurized with 10 bar of argon and the ethylene pressure was brought to 20 bar. The polymerization time was 1 hour, during which time hexene and, if applicable, hydrogen were introduced in the amounts indicated in table III. After 1 hour, the system was depressurized and the polymer was dried under reduced pressure. The polymer was subsequently taken out and weighed.

3.4 Comparative Experiments

Three comparative experiments in which the catalyst preparation and the polymerization were carried out as described under 3.1 to 3.3 except that commercially available products of the type ES 747JR obtainable from Inneos-Silicas (comparative example 2), SG3325A obtainable from Grace (comparative example 3) and Sylopol 2107 obtainable from Grace (comparative example 4) were used as supports in place of a support according to the present invention were carried out.

Table III shows polymerization conditions and productivity for the metallocene catalysts according to the present invention and for comparative experiments.

TABLE III

| | Hexene to | | Productivity |
|---|---|---|---|
| | the reactor | Hydrogen to | [g of polymer/ |
| | [ml] | the reactor [ml] | g of catalyst] |
| Example 6 | 11 | 34 | 673 |
| Example 7 | 24 | 64 | 1509 |
| Example 8 | 16 | 38 | 1050 |
| Example 9 | 9 | 19 | 843 |
| Example 10 | 11 | — | 634 |
| Example 11 | 15 | — | 951 |
| Example 12 | 14 | — | 860 |
| Example 13 | 12 | — | 736 |
| Example 14 | 13 | — | 736 |
| Comparative example 2 | 6 | — | 364 |
| Comparative example 3 | 5 | — | 372 |
| Comparative example 4 | 8 | — | 472 |

It can be seen from the table that the productivity was considerably higher in the examples according to the present invention and the metallocene catalysts according to the present invention displayed a significantly higher productivity in the polymerizations carried out compared to the comparative experiments.

3.5 Polymerization Using Metallocene Catalysts in a Gas-Phase Fluidized-Bed Process

Copolymerizations of ethene with hexene were carried out in the presence of hydrogen as molar mass regulator in a gas-phase reactor. Polymerization was carried out at 95° C.-100° C. and a pressure of 20 bar. Three experiments using supported catalysts according to the present invention were carried out, using nBuMeCp₂ZrCl₂ applied to a support according to the present invention as in batch 3.

The polymerization conditions and analysis of the polymer product are shown in table IV.

3.6 Comparative Experiments

The catalyst preparation and polymerization were carried out as described under 3.1, 3.2 and 3.5, except that a commercially available spray-dried support of the type ES 70X obtainable from Inneos-Silicas was used in place of a support according to the present invention.

Table IV shows the polymerization conditions and analysis of the polymer product obtained using the metallocene catalysts, both catalysts prepared according to the present invention and that of the comparative experiment, in a gas-phase fluidized-bed plant.

TABLE IV

| | | | | Comparative |
|---|---|---|---|---|
| | Example 15 | Example 16 | Example 17 | example 5 |
| P/C [g of pol/ | 3574 | 3446 | 1970 | 2502 |
| g of cat.] | | | | |
| T_{pol.} [° C.] | 95.0 | 95.0 | 95.1 | 100.3 |
| H₂ [l/h] | 4.5 | 4.5 | 3.9 | 1.1 |
| Hexene | 1.20 | 1.20 | 0.92 | 0.90 |
| [% by vol.] | | | | |
| Hexene [g/h] | 460 | 452 | 495 | 220 |
| Output [kg/h] | 5.6 | 5.4 | 5.0 | 3.6 |
| CGC fines | 38 | 26 | 1 | 57 |
| [g/3 h] | | | | |
| Residue [kg] | 20.5 | 19.5 | 18.4 | 10.3 |
| Lumps >5 mm | 22 | 17 | 2 | 636 |
| [g/3 h] | | | | |
| MFR | 2.6 | 2.9 | 5.2 | 1.7 |
| [g/10 min] | | | | |
| Bulk density | 417 | 443 | 425 | 455 |
| [g/l] | | | | |
| Density | 0.9231 | 0.9233 | 0.9221 | 0.9276 |
| [g/cm³] | | | | |
| η [dl/g] | 1.66 | 1.53 | 1.41 | 1.96 |
| Hexene | 5.2 | 5.0 | 6.6 | 2.7 |
| [% by wt.] | | | | |
| M_{w} [g/mol] | 89675 | 90752 | 73162 | 137375 |
| Mₙ [g/mol] | 21831 | 23225 | 20980 | 40604 |
| M_{w}/Mₙ = Q | 4.1 | 3.9 | 3.5 | 3.4 |

Abbreviations:
MFR: melt flow rate (190° C./2.16 kg)
CGC fines: fines discharged from circulating gas cyclone
Lumps: lumps larger than 5 mm

It can be seen from table IV that the amount of fines discharged from the circulating gas cyclone, i.e. the amount of fine dust discharged, is significantly lower in the examples according to the present invention than in the comparative example. The refined dust discharged correlates with deposit and lump formation in the reactor and the proportion of fines formed in the polymerization. As can be seen from the examples, lump formation is considerably lower in the examples according to the present invention than in the comparative example.

1. A process for preparing a supported catalyst which comprises:
a) preparing a hydrogel;
b) milling the hydrogel to give a finely particulate hydrogel;
c) producing a slurry comprising the finely particulate hydrogel;
d) drying the slurry comprising the finely particulate hydrogel thereby forming a support for catalysts;
e) applying a first treatment compound comprising at least one of a transition metal and transition metal containing compound to the support for catalysts thereby forming the supported catalyst; and,
f) optionally activating the supported catalyst, wherein a finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

2. The process for preparing the supported catalyst as claimed in claim 1, wherein the at least one of the transition metal and transition metal comprises transition metals selected from the group consisting of Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg.

3. The process for preparing the supported catalyst as claimed in claim 1, further comprising applying a second treatment compound to the treated support, wherein the second treatment compound comprises at least one of a transition metal and a transition metal containing compound.

4. The process for preparing athe supported catalyst as claimed in wherein claim 1, further comprising applying to the support for catalysts at least one complex of a transition metal.

5. The process for preparing athe supported catalyst as claimed claim 1, wherein the supported catalyst is activated by an activation process selected from at least one of thermal activation, oxidation, halogenation and addition of at least one activator compound.

6. The process for preparing athe supported catalyst as claimed in claim 1, wherein the first treatment compound comprises chromium or a chromium containing compound, and the supported catalyst is activated by at least one of:
a) halogenation,
b) thermal activation in an oxidizing, reducing and/or neutral atmosphere, and
c) renewed thermal activation in a reducing atmosphere,
wherein the thermal activation is carried out in the range from 400° C. to 1000° C.

7. A supported catalyst, prepared by a process comprising
a) preparing a hydrogel;
b) milling the hydrogel to give a finely particulate hydrogel;
c) producing a slurry comprising the finely particulate hydrogel;
d) drying the slurry comprising the finely particulate hydrogel thereby forming a support for catalysts;
e) applying a first treatment compound comprising at least one of a transition metal and transition metal containing compound to the support for catalysts, thereby forming the supported catalyst; and
f) optionally, activating the supported catalyst;
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

8. The supported catalyst as claimed in claim 7 further comprising a chromium content, based on the element, from 0.1% by weight to 5% by weight based on the total weight of the supported catalyst.

9. A process comprising polymerizing and/or copolymerizing olefins with a supported catalyst prepared by a process comprising:
a) preparing a hydrogel;
b) milling the hydrogel to give a finely particulate hydrogel;
c) producing a slurry comprising the finely particulate hydrogel;
d) drying the slurry comprising the finely particulate hydrogel thereby forming a support for catalysts;
e) applying a first treatment compound comprising at least one of a transition metal and transition metal containing compound to the support for catalysts, thereby forming the supported catalyst; and
f) optionally, activating the supported catalyst,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

10. The process of claim 9 wherein the polymerization and/or copolymerization is carried out in the presence of at least one activator compound.

11. The process of claim 10 wherein the activator compound is an organometallic compound.

12. The process of claim 9 wherein the polymerization and/or copolymerization is carried out as a gas-phase fluidized-bed process and/or a suspension process.

13. The process of claim 12 wherein the polymerization and/or copolymerization is carried out in the gas-phase fluidized-bed process and the supported catalyst has a mean particle size of the catalyst particles in the range from 30 μm to 300 μm.

14. The process of claim 12 wherein the polymerization and/or copolymerization is carried out in the suspension process and the supported catalyst has a mean particle size of the catalyst particles in the range from 30 μm to 350 μm.

15. The process of claim 13 wherein, in a polymerization and/or copolymerization in the gas-phase fluidized-bed process, the proportion of discharged polymer having a particle size in the range from >0 μm to ≦125 μm is ≦15% by weight.

16. An olefin polymer obtained from polymerizing and/or copolymerizing olefins with a supported catalyst prepared by a process comprising:
a) preparing a hydrogel;
b) milling the hydrogel to give a finely particulate hydrogel;
c) producing a slurry comprising the finely particulate hydrogel;
d) drving the slurry comprising the finely particulate hydrogel thereby forming a support for catalysts;
e) applying a first treatment compound comprising at least one of a transition metal and transition metal containing compound to the support for catalysts, thereby forming the supported catalyst; and
optionally, activating the supported catalyst,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

17. A fiber, film or molding comprising polymers obtained from polymerizing and/or copolymerizing olefins with a supported catalyst prepared by a process comprising:
a) preparing a hydrogel;
b) milling the hydrogel to give a finely particulate hydrogel;
c) producing a slurry comprising the finely particulate hydrogel;
d) drying the slurry comprising the finely particulate hydrogel thereby forming a support for catalysts;
e) applying a first treatment compound comprising at least one of a transition metal and transition metal containing compound to the support for catalysts, thereby forming the supported catalyst; and
f) optionally, activating the supported catalyst,
wherein the finely particulate hydrogel comprises:
at least 5% by volume of the particles, based on the total volume of the particles, have a particle size in the range from >0 μm to ≦3 μm; and/or
at least 40% by volume of the particles, based on the total volume of the particles, have a particle size in the range from >0 μm to ≦12 μm, and/or
at least 75% by volume of the particles, based on the total volume of the particles, have a particle size in the range from >0 μm to ≦35 μm.

18. The process according to claim 2 wherein the transition metals are selected from the group consisting of Ti, Zr, Cr, Fe, Ni, and Pd.

19. The process according to claim 3 wherein the transition metals are selected from the group consisting of Ti, Zr, Hf, V, Cr, Fe, Co, Ni, Zn and Pd.

20. The process according to claim 4 wherein the at least one complex of a transition metal is a metallocene compound.

21. The process according to claim 20 wherein the metallocene compound comprises a transition metal selected from the group consisting of Ti, Zr, Hf, V, Cr, Fe, Co, Ni, Zn and Pd.

22. The process according to claim 5 wherein the thermal activation is calcination.

23. The process according to claim 5 wherein the halogenation is fluorination.

24. The process according to claim 6 where the thermal activation is carried out in the range from 450° C. to 900° C.

25. The supported catalyst according to claim 8 wherein the chromium content is from 0.2% by weight to 1.5% by weight.

26. The process of claim 11 wherein the organometallic compound comprises a metal selected from the group consisting of B, Al, Zn and Si.

27. The process of claim 13 wherein the mean particle size of the catalyst particles are in the range from 40 μm to 100 μm.

28. The process of claim 14 wherein the mean particle size of the catalyst particles are in the range from 40 μm to 100 μm.

29. The process of claim 15 wherein the proportion of discharged polymer having a particle size in the range from >0 μm to ≦125 μm is ≦5% by weight.

30. The process of claim 29 wherein the proportion of discharged polymer having a particle size in the range from >0 μm to ≦125 μm is ≦3% by weight.

31. The process of claim 30 wherein the proportion of discharged polymer having a particle size in the range from >0 μm to ≦125 μm is from 0.3% by weight to 2% by weight.
